(19) United States
(12) Patent Application Publication
(10) Pub. No.: US 2026/0172988 A1
(43) Pub. Date: Jun. 18, 2026

(54) TECHNIQUES FOR POWER HEADROOM REPORTING

(71) Applicant: QUALCOMM Incorporated, San Diego, CA (US)

(72) Inventors: Qing LI, PRINCETON JUNCTION, NJ (US); Linhai HE, San Diego, CA (US); Ozcan OZTURK, San Diego, CA (US); Gavin Bernard HORN, La Jolla, CA (US)

(21) Appl. No.: 18/981,329

(22) Filed: Dec. 13, 2024

(51) Int. Cl. H04W 52/36; H04W 52/14

(52) U.S. Cl. CPC H04W 52/365; H04W 52/146

(57) ABSTRACT

Methods, systems, and devices for wireless communications are described. In some examples, a user equipment (UE) may receive first control signaling that indicates a plurality of power headroom parameters comprising one or more power headroom thresholds, one or more power headroom variation thresholds, one or more timer values associated respectively with one or more power headroom values, or any combination thereof. The UE may transmit, to a network entity, a power headroom report based on a power headroom satisfying a trigger condition associated with one of the plurality of power headroom parameters. In some examples, the power headroom may be a predicted power headroom determined by the UE.

### FIELD OF TECHNOLOGY

The following relates to wireless communications, including techniques for power headroom reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by a user equipment (UE) is described. The method may include receiving first control signaling that indicates a set of multiple power headroom parameters including one or more power headroom thresholds, one or more power headroom variation thresholds, one or more timer values associated respectively with one or more power headroom values, or any combination thereof and transmitting, to a network entity, a power headroom report based on a first power headroom satisfying a trigger condition associated one of the set of multiple power headroom parameters.

A UE for wireless communication is described. The UE may include one or more memories storing processor executable code, and one or more processors coupled with the one or more memories. The one or more processors may individually or collectively be operable to execute the code to cause the UE to receive first control signaling that indicates a set of multiple power headroom parameters including one or more power headroom thresholds, one or more power headroom variation thresholds, one or more timer values associated respectively with one or more power headroom values, or any combination thereof and transmit, to a network entity, a power headroom report based on a first power headroom satisfying a trigger condition associated one of the set of multiple power headroom parameters.

Another UE for wireless communication is described. The UE may include means for receiving first control signaling that indicates a set of multiple power headroom parameters including one or more power headroom thresholds, one or more power headroom variation thresholds, one or more timer values associated respectively with one or more power headroom values, or any combination thereof and means for transmitting, to a network entity, a power headroom report based on a first power headroom satisfying a trigger condition associated one of the set of multiple power headroom parameters.

A non-transitory computer-readable medium storing code for wireless communication is described. The code may include instructions executable by one or more processors to receive first control signaling that indicates a set of multiple power headroom parameters including one or more power headroom thresholds, one or more power headroom variation thresholds, one or more timer values associated respectively with one or more power headroom values, or any combination thereof and transmit, to a network entity, a power headroom report based on a first power headroom satisfying a trigger condition associated one of the set of multiple power headroom parameters.

In some examples of the method, user equipment (UEs), and non-transitory computer-readable medium described herein, the first power headroom may be a predicted power headroom determined by the UE.

In some examples of the method, user equipment (UEs), and non-transitory computer-readable medium described herein, each of the one or more power headroom variation thresholds may be associated with a respective power headroom value.

In some examples of the method, user equipment (UEs), and non-transitory computer-readable medium described herein, the one or more power headroom variation thresholds include a relative power headroom variation threshold.

In some examples of the method, user equipment (UEs), and non-transitory computer-readable medium described herein, transmitting the power headroom report may include operations, features, means, or instructions for transmitting the power headroom report based on the trigger condition including a power headroom variation satisfying the one or more power headroom variation thresholds, where the power headroom variation may be based on the first power headroom determined at a first time and a second power headroom determined at a second time.

In some examples of the method, user equipment (UEs), and non-transitory computer-readable medium described herein, the one or more timer values associated respectively with the one or more power headroom values include one or more periodic timer values associated respectively with the one or more power headroom values or one or more prohibit timer values associated respectively with the one or more power headroom values.

In some examples of the method, user equipment (UEs), and non-transitory computer-readable medium described herein, the one or more timer values associated respectively with the one or more power headroom values include a look up table or a mapping function.

In some examples of the method, user equipment (UEs), and non-transitory computer-readable medium described herein, transmitting the power headroom report may include operations, features, means, or instructions for determining one of the one or more timer values based on the first power headroom and transmitting the power headroom report based on the trigger condition including an expiration of the one of the one or more timer values.

Some examples of the method, user equipment (UEs), and non-transitory computer-readable medium described herein may further include operations, features, means, or instructions for receiving second control signaling that indicates one or more parameters for prediction of an uplink grant.

In some examples of the method, user equipment (UEs), and non-transitory computer-readable medium described herein, transmitting the power headroom report may include operations, features, means, or instructions for predicting an uplink grant and transmitting the power headroom report based on the trigger condition associated with the uplink grant.

In some examples of the method, user equipment (UEs), and non-transitory computer-readable medium described herein, the trigger condition includes the uplink grant being associated with the first power headroom being less than the one or more power headroom thresholds.

In some examples of the method, user equipment (UEs), and non-transitory computer-readable medium described herein, the trigger condition includes the uplink grant being associated with a power headroom variation being greater than the one or more power headroom variation thresholds and the power headroom variation may be based on the first power headroom determined at a first time and a second power headroom determined at a second time.

Some examples of the method, user equipment (UEs), and non-transitory computer-readable medium described herein may further include operations, features, means, or instructions for transmitting assistance information that indicates a prediction capability or a set of UE power headroom parameters associated with the power headroom report.

In some examples of the method, user equipment (UEs), and non-transitory computer-readable medium described herein, the set of multiple power headroom parameters may be based on the prediction capability or the set of UE power headroom parameters.

Some examples of the method, user equipment (UEs), and non-transitory computer-readable medium described herein may further include operations, features, means, or instructions for receiving second control information that indicates a request for the power headroom report.

Some examples of the method, user equipment (UEs), and non-transitory computer-readable medium described herein may further include operations, features, means, or instructions for receiving second control information that indicates a request to enable a predicted power headroom.

A method for wireless communication by a network entity is described. The method may include outputting first control signaling that indicates a set of multiple power headroom parameters including one or more power headroom thresholds, one or more power headroom variation thresholds, one or more timer values associated respectively with one or more power headroom values, or any combination thereof and obtaining a power headroom report based on a first power headroom satisfying a trigger condition associated with one of the set of multiple power headroom parameters.

A network entity for wireless communication is described. The network entity may include one or more memories storing processor executable code, and one or more processors coupled with the one or more memories. The one or more processors may individually or collectively be operable to execute the code to cause the network entity to output first control signaling that indicates a set of multiple power headroom parameters including one or more power headroom thresholds, one or more power headroom variation thresholds, one or more timer values associated respectively with one or more power headroom values, or any combination thereof and obtain a power headroom report based on a first power headroom satisfying a trigger condition associated with one of the set of multiple power headroom parameters.

Another network entity for wireless communication is described. The network entity may include means for outputting first control signaling that indicates a set of multiple power headroom parameters including one or more power headroom thresholds, one or more power headroom variation thresholds, one or more timer values associated respectively with one or more power headroom values, or any combination thereof and means for obtaining a power headroom report based on a first power headroom satisfying a trigger condition associated with one of the set of multiple power headroom parameters.

A non-transitory computer-readable medium storing code for wireless communication is described. The code may include instructions executable by one or more processors to output first control signaling that indicates a set of multiple power headroom parameters including one or more power headroom thresholds, one or more power headroom variation thresholds, one or more timer values associated respectively with one or more power headroom values, or any combination thereof and obtain a power headroom report based on a first power headroom satisfying a trigger condition associated with one of the set of multiple power headroom parameters.

In some examples of the method, network entities, and non-transitory computer-readable medium described herein, the first power headroom may be a predicted power headroom determined by a UE.

In some examples of the method, network entities, and non-transitory computer-readable medium described herein, each of the one or more power headroom variation thresholds may be associated with a respective power headroom value.

In some examples of the method, network entities, and non-transitory computer-readable medium described herein, the one or more power headroom variation thresholds include a relative power headroom variation threshold.

In some examples of the method, network entities, and non-transitory computer-readable medium described herein, the one or more timer values associated respectively with the one or more power headroom values include one or more periodic timer values associated respectively with the one or more power headroom values or one or more prohibit timer values associated respectively with the one or more power headroom values.

In some examples of the method, network entities, and non-transitory computer-readable medium described herein, the one or more timer values associated respectively with the one or more power headroom values include a look up table or a mapping function.

Some examples of the method, network entities, and non-transitory computer-readable medium described herein may further include operations, features, means, or instructions for outputting second control signaling that indicates one or more parameters for prediction of an uplink grant.

Some examples of the method, network entities, and non-transitory computer-readable medium described herein may further include operations, features, means, or instructions for obtaining assistance information that indicates a prediction capability or a set of UE power headroom parameters of a UE associated with the power headroom report.

In some examples of the method, network entities, and non-transitory computer-readable medium described herein, the set of multiple power headroom parameters may be based on the prediction capability or the set of UE power headroom parameters.

Some examples of the method, network entities, and non-transitory computer-readable medium described herein may further include operations, features, means, or instructions for outputting second control information that indicates a request for the power headroom report.

Some examples of the method, network entities, and non-transitory computer-readable medium described herein may further include operations, features, means, or instructions for outputting second control information that indicates a request to enable a predicted power headroom.

Some examples of the method, network entities, and non-transitory computer-readable medium described herein may further include operations, features, means, or instructions for outputting second control information that indicates a modification to the set of multiple power headroom parameters based on the power headroom report.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for power headroom reporting in accordance with one or more aspects of the present disclosure.

FIG. 2 shows an example of a wireless communications system that supports techniques for power headroom reporting in accordance with one or more aspects of the present disclosure.

FIG. 3 shows an example of a timer value diagram that supports techniques for power headroom reporting in accordance with one or more aspects of the present disclosure.

FIG. 4 shows an example of a block diagram that supports techniques for power headroom reporting in accordance with one or more aspects of the present disclosure.

FIG. 5 shows an example of a process flow that supports techniques for power headroom reporting in accordance with one or more aspects of the present disclosure.

FIGS. 6 and 7 show block diagrams of devices that support techniques for power headroom reporting in accordance with one or more aspects of the present disclosure.

FIG. 8 shows a block diagram of a communications manager that supports techniques for power headroom reporting in accordance with one or more aspects of the present disclosure.

FIG. 9 shows a diagram of a system including a device that supports techniques for power headroom reporting in accordance with one or more aspects of the present disclosure.

FIGS. 10 and 11 show block diagrams of devices that support techniques for power headroom reporting in accordance with one or more aspects of the present disclosure.

FIG. 12 shows a block diagram of a communications manager that supports techniques for power headroom reporting in accordance with one or more aspects of the present disclosure.

FIG. 13 shows a diagram of a system including a device that supports techniques for power headroom reporting in accordance with one or more aspects of the present disclosure.

FIGS. 14 and 15 show flowcharts illustrating methods that support techniques for power headroom reporting in accordance with one or more aspects of the present disclosure.

### DETAILED DESCRIPTION

In some wireless communications systems, a user equipment (UE) may transmit a power headroom report to a network entity. The power headroom report may indicate an available power headroom relative to a transmission power threshold. The power headroom report may assist the network entity with efficient power control and resource management. A power headroom reporting procedure may be initiated by trigger conditions. The trigger conditions may include an expiration of a power headroom report periodic timer, an expiration of a power headroom report prohibit timer, and a path loss change exceeding a threshold. Some data traffic communicated by the UE to the network entity may have dynamic quality of service requirements, dynamic packet burst patterns, and different transmit power control requirements. In some cases, the UE may collect data and implement artificial intelligence or machine learning (AI/ML) models to predict the power headroom. The trigger conditions based on the network entity configured timers and pathloss threshold may not provide flexibility to consider the UE predictions of the power headroom or may not be suitable for data traffic with dynamic quality of service requirements, dynamic packet burst patterns, and different transmit power control requirements.

Techniques for power headroom reporting may be employed. In some examples, a triggering condition for the power headroom report may be based on a power headroom change threshold, a timer associated with a power headroom value, or an uplink grant prediction or power headroom prediction. For example, the UE may receive control signaling (e.g., radio resource control (RRC) signaling) that indicates a plurality of power headroom parameters. The plurality of power headroom parameters may include power headroom thresholds, power headroom variation thresholds, or timer values associated with a respective power headroom value. The UE may transmit, to the network entity, a power headroom report based on a power headroom satisfying a trigger condition associated with one of the plurality of power headroom parameters. In some cases, the UE may predict the power headroom. In some cases, the power headroom variation thresholds may be associated with a respective power headroom value.

Aspects of the disclosure are initially described in the context of wireless communications systems. Aspects of the disclosure are further illustrated by and described with reference to a timing value diagram, a block diagram, a process flow, apparatus diagrams, system diagrams, and flowcharts that relate to techniques for power headroom reporting.

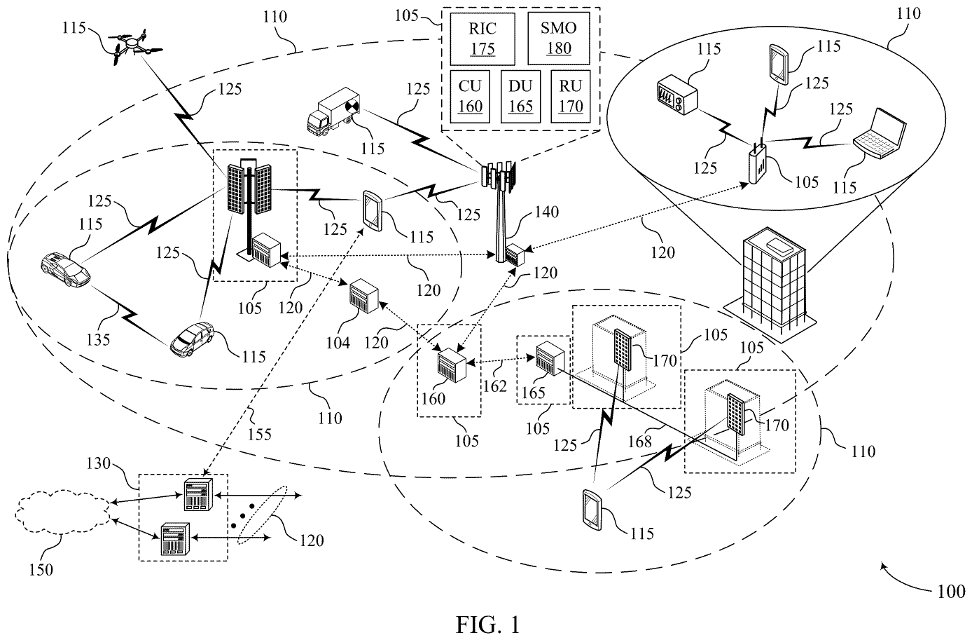

FIG. 1 shows an example of a wireless communications system 100 that supports techniques for power headroom reporting in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support techniques for power headroom reporting as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some wireless communications systems, the UE 115 may transmit a power headroom report to the network entity 105. The power headroom report indicates an available power headroom relative to a transmission power threshold. The power headroom report may assist the network entity 105 with efficient power control and resource management. A power headroom reporting procedure may be initiated by trigger conditions. The trigger conditions may include an expiration of a power headroom report periodic timer, an expiration of a power headroom report prohibit timer and a path loss change exceeding a threshold. In some cases, the UE 115 may collect data and implement AI/ML models to predict the power headroom. The trigger conditions based on the network entity configured timers and pathloss threshold may not provide flexibility to consider the UE predictions of the power headroom.

Techniques for power headroom reporting may be employed. In some examples, the UE 115 may receive control signaling (e.g., RRC signaling) that indicates a plurality of power headroom parameters. The plurality of power headroom parameters may include power headroom thresholds, power headroom variations thresholds, or timer values, where each of the timer values may be associated with a power headroom value. The UE 115 may transmit, to the network entity 105, a power headroom report based on a power headroom, such as a predicted power headroom, satisfying a trigger condition associated with one of the plurality of power headroom parameters. For example, the trigger condition may be a power headroom variation satisfying a power headroom variation threshold. The trigger condition may be an expiration of the timer value.

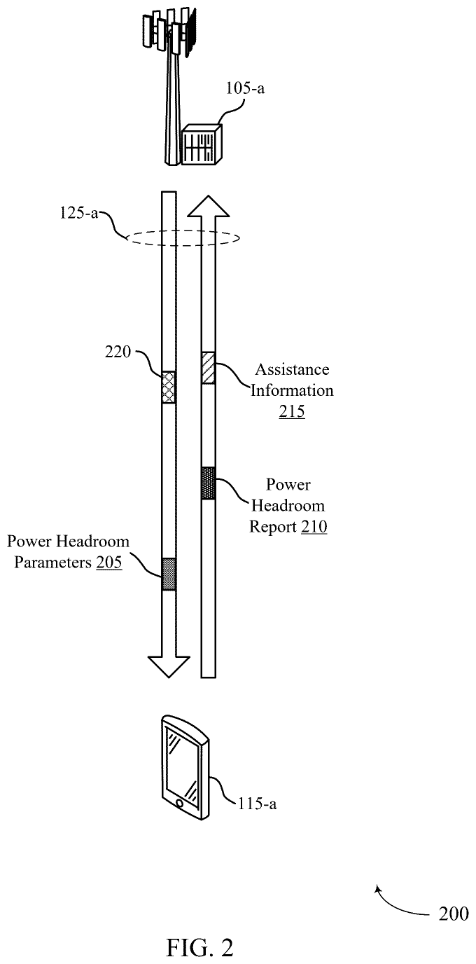

FIG. 2 shows an example of a wireless communications system 200 that supports techniques for power headroom reporting in accordance with one or more aspects of the present disclosure. The wireless communications system 200 may implement or may be implemented by aspects of the wireless communications system 100. For example, the wireless communications system 200 may include a UE 115-a, which may be an example of a UE 115 as described herein. The wireless communications system 200 may include a network entity 105-a, which may be an example of a network entity 105 as described herein.

In some examples, the UE 115-a may communicate with the network entity 105-a using a communication link 125-a. The communication link 125-a may be an example of a 6th generation (6G), a NR or LTE link between the UE 115-a and the network entity. The communication link 125-a may include a bi-directional link that enable both uplink and downlink communications. For example, the UE 115-a may transmit uplink signals (e.g., uplink transmissions), such as uplink reference signals, uplink control signals or uplink data signals, to the network entity 105-a using the communication link 125-a and the network entity 105-a may transmit downlink signals (e.g., downlink transmissions), such as downlink reference signals, downlink control signals or downlink data signals, to the UE 115-a using the communication link 125-a.

In some examples, the UE 115-a may determine a power headroom that indicates an available power headroom relative to a transmission power threshold. In some cases, the UE 115-a may determine a Type 1 power headroom report for an activated serving cell (e.g., network entity 105-a), that is based on an actual PUSCH transmission (e.g., PUSCH transmission occasion i on active uplink (UL) bandwidth part (BWP) b of a carrier f of serving cell c), by computing the Type 1 power headroom report as

$${PH}_{type , b , f , c} ( i , j , {q}_{d} , l ) = {P}_{CMAX , f , c}^{′} ( i ) - \{ {P}_{O \_ PUSCH , b , f , c} ( j ) + 10 {log}_{10} ( {2}^{μ} \cdot {{M}^{′}}_{RB , b , f , c}^{PUSCH} ( i ) ) + {α}_{b , f , c} ( j ) \cdot {PL}_{b , f , c} ( {q}_{d} ) + {Δ}_{TF , b , f , c}^{′} ( i ) + {f}_{b , f , c} ( i , l ) \} [ dB ] .$$

The P′_{CMAX,f,c}(i) is the UE selected configured maximum output power within a configured or activated range of configured maximum output power P_{CMAX,f,c} for the carrier f of serving cell c in PUSCH transmission occasion i, based on power reduction or power boost to P_{CMAX,f,c}. In the power headroom report, the transmitting UE 115-a may indicate the P′_{CMAX,f,c} with either power boost or power reduction (e.g., Pcmax_flag=0/1 for boosting or Pcmax_flag=I/O for reducing). The UE 115-a may also indicate a cause code of power boost (e.g., a cause code for coverage enhancement, quality of service (QoS) such as reliable or short latency, or bursty throughput) or a cause code of the power reduction (e.g., a cause code for sensing, multi-RAT, maximum permissible exposure (MPE), maximum power reduction (MPR), interference, or energy saving). The

$${{M}^{′}}_{RB , b , f , c}^{PUSCH} ( i )$$

is the UE selected bandwidth of the PUSCH resource within a configured or activated range of assignment expressed in quantity of resource blocks for PUSCH transmission occasion i on active UL BWP b of carrier f of serving cell c and the μ is a subcarrier spacing (SCS) configuration used to scale the UE selected bandwidth of the PUSCH resource. In the power headroom report, the transmitting UE 115-a may indicate the determined multiple resource block (MRB′) within a configured or activated RB range with either resource block (RB) increment or decrement indication (e.g., MRB_flag=0/1 for increasing RBs or MRB_flag=1/0 for decreasing RBs) and may indicate a cause code of RB adjustment (e.g., increasing the RB number with a cause code for a short latency or bursty transmission or decreasing the RB number with a cause code for coverage or energy saving). The

$${Δ}_{TF , b , f , c}^{′} ( i ) = 10 {log}_{10} ( ( {2}^{BPRE \cdot {K}_{s}} - 1 ) \cdot {β}_{offset}^{PUSCH} ) for {K}_{s} = 1.25 and {Δ}_{TF , b , f , c} ( i ) = 0 for {K}_{s} = 0$$

where Kₛ is provided by deltaMCS′ selected by the UE 115-a from a configured or activated list or range of modulation and coding scheme (MCS) for each UL BWP b of each carrier f and serving cell c. If the PUSCH transmission is over more than one layer, Δ_{TF,b,f,c}(i)=0. In the power headroom report, the UE 115-a may indicate the determined MCS' with either MCS increment or decrement indication (e.g., MCS_flag=0/1 for increasing MCS or MCS_flag=I/O for decreasing MCS), and the UE 115-a may indicate a cause code of the MCS adjustment (e.g., increasing the MCS number with a cause code for a short latency or bursty transmission or decreasing the RB number with a cause code for coverage or energy saving).

In some cases, the power headroom reporting procedure may be controlled via timers and thresholds that may be configured by the network entity 105-a for the UE 115-a via an RRC parameter PHR-Config under an information element MAC-CellGroupConfig. In some examples, the power headroom report may be triggered based on a triggering condition of a power headroom periodic timer (e.g., phr-PeriodicTimer) expires. In some cases, the triggering condition may be a power headroom prohibit timer (e.g., phr-ProhibitTimer) expires or has expired and a path loss change is greater than a threshold (e.g., phr-Tx-PowerFactorChange dB). In some cases, the trigger condition may be the power headroom prohibit timer (e.g., phr-ProhibitTimer) expires or has expired, when the MAC entity has UL resources for a new transmission, and the following is true for any of the activated Serving Cells, UL resources are allocated for transmission or a PUCCH transmission is allocated on the cell, and the power backoff due to power management (as allowed by P-MPR_{c}) for the cell has changed more than a power factor change threshold (e.g., phr-Tx-PowerFactorChange dB). In some examples, the trigger condition may be whether a delta power class reporting (e.g., dpc-Reporting-FR1) is configured, such as ΔP_{PowerClass}, ΔP_{PowerClass}, CA, ΔP_{PowerClass}, EN-DC, or ΔP_{PowerClass}, NR-DC, and reporting may be triggered based on uplink duty cycle exceedance or based on return to the power class after the duty cycle exceedance. In some examples, an MPE P-MPR report may be triggered based on a triggering condition of the MPE reporting (e.g., mpe-Reporting-FR2) being configured and an MPE prohibit timer (e.g., mpe-ProhibitTimer) is not running, and the measured P-MPR is greater than or equal to a threshold (e.g., mpe-Threshold) or the measured P-MPR change is greater than a threshold (e.g., phr-Tx-PowerFactorChange dB).

Some data traffic communicated by the UE 115-a to the network entity 105-a may have dynamic quality of service requirements, dynamic packet burst patterns, and different transmit power control requirements. For example, 6G traffic characteristics may be diversified. In some cases, the UE 115-a may collect data on the UE side to enable smart UE implementations. In some examples, AI/ML features may empower the UE 115-a to implement better decisions for UE transmissions. In some cases, techniques for more flexible power headroom reporting are desired to support AI/ML capability and 6G data traffic.

In some examples, the power headroom report may be triggered based on measured or predicted power headroom at the UE 115-a. As discussed herein, the power headroom may be determined with

$${P}_{CMAX , f , c}^{′} ( i ) , {{M}^{′}}_{RB , b , f , c}^{PUSCH} ( i ) , {Δ}_{TF , b , f , c}^{′} ( i )$$

and a pathloss PL_{b,f,c}(qd), and these quantities may be determined or predicted by the UE 115-a. A trigger condition for the power headroom report may be based on a variation of the power headroom, such as a power headroom change threshold (e.g., phr-Tx-PHChange) instead of the pathloss change (e.g., pathloss change threshold phr-Tx-PowerFactorChange). In some examples, the triggering condition may be adapted based on the powerhead room calculated, or based on measurement by the UE 115-a, or the power headroom predicted based on the AI/ML inference or prediction at the UE 115-a.

In some cases, the triggering conditions may include multiple power headroom thresholds or multiple power headroom variation thresholds. Each power headroom variation threshold may be associated with a respective power headroom value. For example, a smaller value of power headroom (e.g., a power headroom associated with a transmit power close to the maximum transmit power) may be associated with a smaller value of the power headroom change threshold for triggering the power headroom report. A larger value of power headroom (e.g., a power headroom with a transmit power far below the maximum transmit power) may be associated with a larger value of the power headroom change threshold for triggering the power headroom report. In some cases, a list of power headroom change threshold values (e.g., phr-Tx-PHChange-list) may be associated with a list of power headroom values (e.g., phr-Tx-PH-list). In some cases, a look up table (LUT) or a mapping function may provide the triggering variation thresholds and the associated power headroom values. In some examples, a relative power headroom change threshold (e.g., phr-Tx-PHChangeRelative) may be used for triggering the power headroom report. For example, a power headroom change may be scaled or normalized with a power headroom value (e.g., the power headroom variation may be x % of the calculated or predicted power headroom value using the ratio of the power headroom variation divided by the power headroom or

$$\frac{Δ PH}{PH} \times 100 \% ) .$$

In some cases, the network entity 105-a may configure, reconfigure, or activate the multiple power headroom change thresholds or the relative power headroom change threshold. For example, the UE 115-a may receive, from the network entity 105-a, control signaling 205 that indicates a plurality of power headroom parameters. The control signaling 205 may indicate the multiple power headroom change or variation thresholds or the relative power headroom change threshold. The UE 115-a may transmit a power headroom report 210 based on a predicted power headroom or a measured power headroom (e.g., power headroom determined with measurements) satisfying a trigger condition associated with one of the multiple power variation thresholds or with the relative power headroom change threshold.

In some cases, the power headroom report timers may be adapted based on the measured or predicted power headroom. Power headroom indicates how much transmission power is left for the UE 115-a to use in addition to the power being used by current transmission, so that the UE 115-a will not exceed the maximum allowed transmit power. With power headroom report timers adapted with different values of power headroom, the power headroom report operations may reduce the power headroom report message overhead. For example, timers used for power headroom reporting operation may be adapted based on power headroom margin.

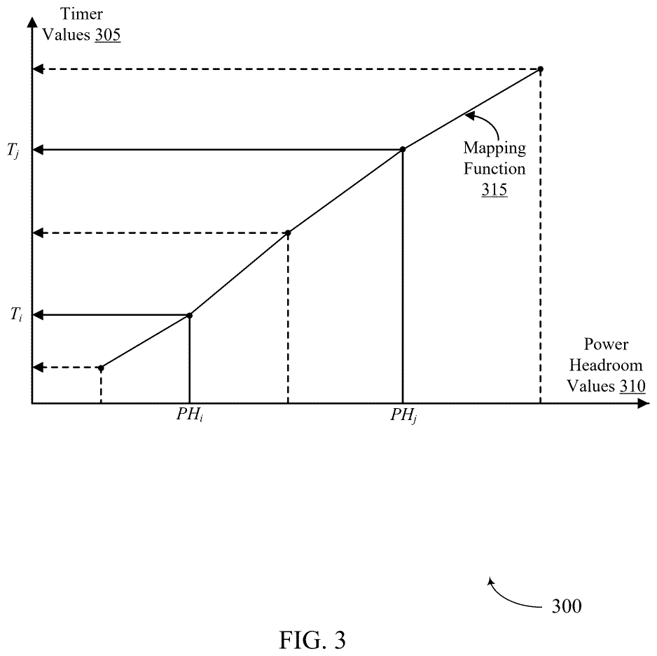

FIG. 3 shows an example of a timer value diagram 300 that supports techniques for power headroom reporting in accordance with one or more aspects of the present disclosure. The timer value diagram 300 illustrates timer values and corresponding power headroom values. The timer value diagram 300 may implement or be implemented by one or more aspects described with reference to FIGS. 1 and 2. For example, the network entity 105 a may provide configure the UE 115-a with the timer values and their associated power headroom values.

The timer value diagram 300 illustrates the respective association between time values 305 and power headroom values 310. With a smaller value of power headroom (e.g., the power headroom PHᵢ with a transmit power close to the maximum transmit power), a timer value may be tightened for more frequent power headroom reports (e.g., the Tᵢ for a shorter periodic timer or a shorter prohibit timer for power headroom reporting). With a larger value of power headroom (e.g., the power headroom PHⱼ with a transmit power far below the maximum transmit power), a timer value may be relaxed for less frequent power headroom reporting (e.g., the Tⱼ for a longer periodic timer or prohibit timer for power headroom reporting).

In some cases, the network entity 105-a may configure the association between a power headroom value (e.g., PHᵢ or PHⱼ) and a timer value (e.g., Tᵢ or Tⱼ) for the power headroom report periodic timer phr-PeriodicTimer or the prohibit timer phr-ProhibitTimer). For example, the UE 115-a may receive, from the network entity 105-a, control signaling 205 that indicates one or more timer values associated respectively with one or more power headroom values. In some examples, the network entity 105-a may provide a look up table (LUT) (e.g., a list of timer values associated with a list of power headroom values) or a mapping function (e.g., a linear function, a piece-wise linear function or other function, such as the mapping function 315 as shown in FIG. 3). The UE 115-a may determine a timer value based on a power headroom (e.g., set a timer value when start or restart phr-PeriodicTimer or phr-ProhibitTimer based on the measured power headroom (e.g., power headroom determined using the measured data) or the predicted power headroom (e.g., power headroom estimated using an algorithm or an AL/ML model).

In some examples, the power headroom report operation may be based on uplink grant prediction or power headroom prediction. Based on a received power headroom report, the network entity 105-a may estimate how much uplink bandwidth (e.g., resources) the UE 115-a may use for a specific transmission or how much transmit power adjustment the UE 115-a may apply so that the UE transmit power should not exceed the maximum transmit power. On the UE side, the UE 115-a may predict an uplink grant or power headroom and may determine to send a power headroom report based on the predicted uplink grant or predicted power headroom. For example, a power headroom report transmission may be triggered if a predicted UL grant causes the power headroom to be less than a power headroom threshold or a power headroom change to be greater than a power headroom variation threshold. The power headroom report may not be triggered if the predicted UL grant does not cause the power headroom less than a threshold or the power headroom change greater than a threshold. For example, a power headroom report transmission may be triggered if a predicted power headroom is less than a power headroom threshold or a power headroom change is greater than a power headroom variation threshold. The power headroom report may not be triggered if the predicted power headroom is not less than a threshold or the power headroom change is not greater than a threshold.

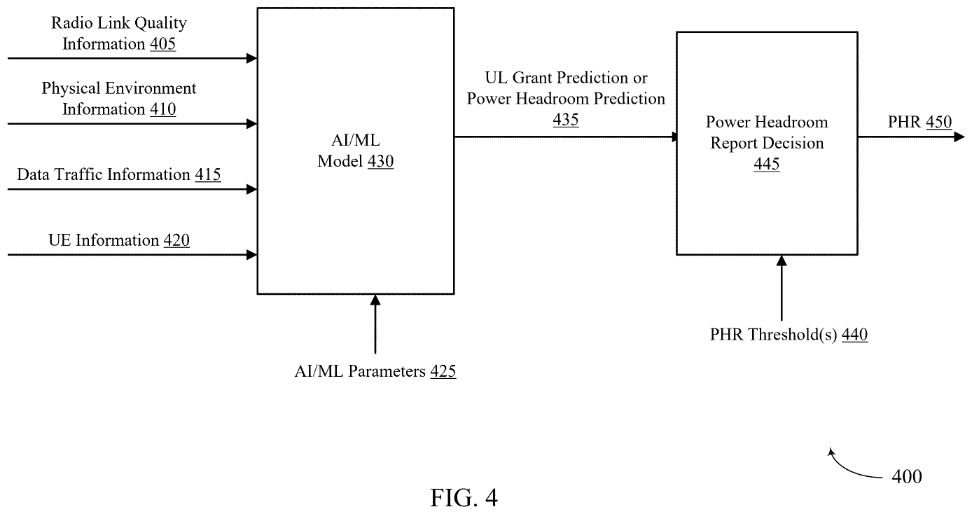

FIG. 4 shows an example of a block diagram 400 that supports techniques for power headroom reporting in accordance with one or more aspects of the present disclosure. The block diagram 400 illustrates an uplink grant prediction and power headroom reporting process. The block diagram 400 may implement or be implemented by one or more aspects described with reference to FIGS. 1 and 2. For example, the UE 115-a may implement the block diagram 400.

The block diagram 400 illustrates the uplink grant prediction and power headroom reporting process. The UE 115-a may include an AI/ML model 430 for predicting the uplink grant or power headroom. Radio link quality information 405 may be an input to the AI/ML model 430. The radio link quality information 405 may include a radio link measurement or prediction (e.g., Layer 1 beam-based measurement or prediction, Layer 2, or Layer 3 filtered measurement or prediction), a channel propagation type (line-of-sight (LOS) or non-LOS) or fading pattern measured or predicted, interference measured or predicted, or a radio map (e.g., indicating a distribution of signal strength (such as RSSI, SINR, RSRP or RSRQ) across a geographic area or spatial angular range). Physical environment information 410 may be an input to the AI/ML model 430. The physical environment information 410 may include static blocking or reflecting objects (e.g., buildings, structures, or trees), dynamic blocking or reflecting objects (e.g., bus or truck passing by) which may be detected or predicted, human body detection or prediction (e.g., for MPE regulation), or other UEs detected or predicted (e.g., for inter-UE interference).

In some cases, data traffic information 415 may be an input to the AI/ML model 430. The data traffic information 415 may include data traffic characteristics of statistics or prediction of buffer status report (BSR) or delay status report (DSR) or the like, statistics or prediction of data flow patterns associated with one or more QoS flows (e.g., multi-modal data with different volume, latency, reliability, bursty, or arrival patterns) or one or more energy allocations or budgets, and statistics or prediction of quantity of retransmissions or data drops. In some examples, UE information 420 may be an input to the AI/ML model. The UE information 420 may include UE location, orientation, velocity, device temperature (e.g., avoid overheating), battery level, transmit power statist, or transmit power map (e.g., indicating a distribution of transmit power across a geographic area or spatial angular range).

In some cases, AI/ML parameters 425 may be an input to the AI/ML model 430. The AI/ML parameters 425 may be configured or activated by the network entity 105-a for managing the AI/ML model inference. The AI/ML parameters 425 may include information associated with the AI/ML model, such as model architecture, bit width, lifetime span, model update cycle, accuracy requirement, misprediction or false alarm requirement. The AI/ML parameters 425 may include parameters for inference or prediction of an UL grant or power headroom, such as an uplink configuration including UL BWP, expected block error rate (BLER), QoS such as reliability and latency, scheduling policy, energy budget or allocation, one or more rewards (e.g., power saving rewards, interference reduction rewards, scheduling rewards).

Based on the inputs and AI/ML parameters 425, the AI/ML model 430 may output an UL grant prediction or a power headroom prediction 435. Using the configured or activated power headroom report threshold(s) 440 and the UL grant prediction or power headroom prediction 435, the power headroom decision 445 determines whether the trigger condition is satisfied, and if so, outputs the power headroom report 450. The UE 115-a may transmit, to the network entity 105-a, the power headroom report.

In some examples, the network entity 105-a may manage the power headroom reporting operation. The UE 115-a may indicate an AI/ML capability or UE assistance information with the power headroom report. In some cases, the UE 115-a, may transmit, to the network entity 105-a, assistance information 215 (as shown in FIG. 2) that indicates a prediction capability (e.g., AI/ML based power headroom prediction capability) or a set of UE power headroom parameters. The set of UE power headroom parameters may be the UE preferred or supported power headroom parameters, and may be based on UE capability or UE measurements and predictions.

In some cases, the network entity 105-a may determine and configure the AI/ML based power headroom parameters based on UE AI/ML capability. In some cases, the network entity 105-a may configure one or more associations (e.g., LUTs) between power headroom values and power headroom report triggering thresholds. The network entity 105-a may configure one or more associations (e.g., LUTs) between power headroom values and timer values (e.g., phr-PeriodicTimer or phr-ProhibitTimer). The network entity 105-a may configure one or more thresholds for determining power headroom report transmission based on predicted UL grant or predicted power headroom.

In some examples, the network entity 105-a may monitor and control the AI/ML based power headroom parameters (e.g., AI/ML parameters 425 as shown in FIG. 4). In some examples, the network entity 105-a may reconfigure or activate one or more parameters (e.g., an association between power headroom values and power headroom report triggering thresholds, an association between power headroom values and timer values, a threshold for determining power headroom report transmission based on predicted UL grant or predicted headroom). The network entity 105-a may activate or deactivate the one or more parameters. The network entity 105-a may indicate a fall back to a non-AI/ML based configuration (e.g., a threshold, a timer value not associated with predicted power headroom) based on performance monitoring of AI/ML based UL grant prediction or power headroom prediction.

In some cases, the reconfiguration, activation, or deactivation by the network entity 105-a may be based on monitoring of system interference level, network throughput, a quantity of UEs transmitting, or a received power of a transmission from the UE 115-a and the associated decoding of the transmission. In some cases, the network entity 105-a may indicate (e.g., via MAC CE or DCI), for one or more UL transmission instances whether a power headroom report is requested (i.e., polling for the power headroom report with a flag bit with “0” or “1”) or whether AI/ML based power headroom reporting is enabled or disabled (e.g., with a flag bit with “0” or “1”). For example, the UE 115-a may receive, from the network entity 105-a, control signal 220 that indicates a request for the power headroom report or that indicates a request to enable a predicted power headroom.

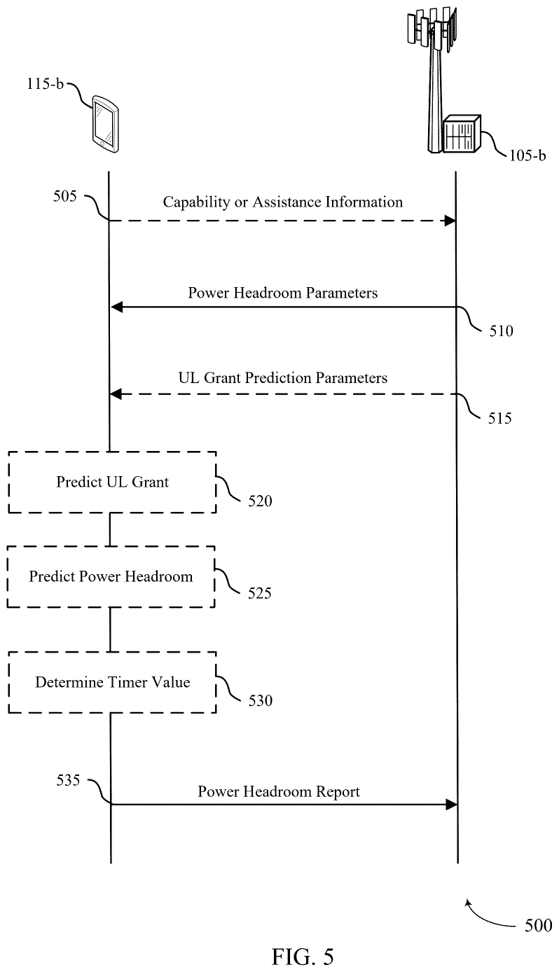

FIG. 5 shows an example of a process flow 500 that supports techniques for power headroom reporting in accordance with one or more aspects of the present disclosure. The process flow 500 may implement or may be implemented by aspects of the wireless communications system 100 and the wireless communications system 200. For example, the process flow 500 may include a UE 115-b and a network entity 105-b which may be examples of corresponding devices and entities as described with reference to FIGS. 1 and 2. In the following description of the process flow 500, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 500, and other operations may be added to the process flow 500.

At 505, the UE 115-b may transmit, to the network entity 105-b, capability or assistance information that indicates a prediction capability or a set of UE power headroom parameters.

At 510, the UE 115-b may receive, from the network entity 105-b, control signaling that indicates a plurality of power headroom parameters. The plurality of power headroom parameters may include one or more power headroom thresholds, one or more power headroom variation thresholds, one or more timer values associated respectively with one or more power headroom values, or any combination thereof. In some cases, each of the one or more power headroom variation thresholds may be associated with a respective power headroom value. In some examples, the one or more power headroom variation thresholds may include a relative power headroom variation threshold. In some cases, the one or more timer values associated respectively with the one or more power headroom values may include one or more periodic timer values associated respectively with the one or more power headroom values or one or more prohibit timer values associated respectively with the one or more power headroom values. In some examples, the one or more timer values associated respectively with the one or more power headroom values may include a look up table or a mapping function. In some cases, the plurality of power headroom parameters may be based on the prediction capability or the set of UE power headroom parameters.

Additionally, or alternatively, the UE 115-b may receive, from the network entity 105-b, control signaling that indicates a plurality of AI/ML parameters. The plurality of power headroom parameters may include one or more power headroom thresholds, one or more power headroom variation thresholds, one or more timer values associated respectively with one or more power headroom values, or any combination thereof. In some cases, each of the one or more power headroom variation thresholds may be associated with a respective power headroom value. In some examples, the one or more power headroom variation thresholds may include a relative power headroom variation threshold. In some cases, the one or more timer values associated respectively with the one or more power headroom values may include one or more periodic timer values associated respectively with the one or more power headroom values or one or more prohibit timer values associated respectively with the one or more power headroom values. In some examples, the one or more timer values associated respectively with the one or more power headroom values may include a look up table or a mapping function. In some cases, the plurality of power headroom parameters may be based on the prediction capability or the set of UE power headroom parameters.

At 515, additionally, or alternatively, the UE 115-b may receive, from the network entity 105-b, control signaling that indicates a plurality of AI/ML parameters for prediction of an uplink grant or prediction of a power headroom (e.g., as describe in detail in the connection with the AI/ML parameters 425 in FIG. 4.).

At 520, the UE 115-b may predict an uplink grant. In some cases, the predicted uplink grant may be based on the radio link quality information (e.g., the radio link quality information 405 in FIG. 4), physical environment information (e.g., the physical environment information 410 in FIG. 4), data traffic information (e.g., the data traffic information 415 in FIG. 4), UE information (e.g., the UE information 420 in FIG. 4), AI/ML parameters (e.g., the AI/ML parameters 425 in FIG. 4), or any alike, for prediction of the uplink grant.

At 525, the UE 115-b may predict a power headroom. In some cases, the predicted power headroom may be based on the radio link quality information (e.g., the radio link quality information 405 in FIG. 4), physical environment information (e.g., the physical environment information 410 in FIG. 4), data traffic information (e.g., the data traffic information 415 in FIG. 4), UE information (e.g., the UE information 420 in FIG. 4), AI/ML parameters (e.g., the AI/ML parameters 425 in FIG. 4), or any alike, for prediction of the power headroom. In some cases, the UE 115-b may receive control signaling that indicates a request to enable an AI/ML based UL grant prediction or power headroom prediction. In some cases, the UE 115-b may measure the power headroom.

At 530, the UE 115-b may determine one of the one or more timer values based on the power headroom. The UE 115-b may determine a value for phr-PeriodicTimer and/or a value for phr-ProhibitTimer based on the predicted or measured power headroom.

At 535, the UE 115-b may transmit, to the network entity 105-b, a power headroom report based on the power headroom satisfying a trigger condition associated one of the plurality of power headroom parameters. In some cases, the UE 115-b may transmit the power headroom report based on the trigger condition of a power headroom variation satisfying the one or more power headroom variation thresholds, and the power headroom variation is based on the power headroom determined at a first time and another power headroom determined at a second time. In some cases, the UE 115-b may transmit the power headroom report based on the trigger condition of an expiration of a timer with a determined timer value (e.g., an expiration of the PHR periodic timer with a determined value phr-PeriodicTimer based on the predicted or measured power headroom or an expiration of the PHR prohibit timer with a determined value phr-ProhibitTimer based on the predicted or measured power headroom). In some examples, the UE 115-b may transmit the power headroom report based on the trigger condition associated with an uplink grant, and the trigger condition associated with the uplink grant includes the uplink grant being associated with the power headroom being less than the one or more power headroom thresholds. In some cases, the trigger condition comprises an uplink grant being associated with a power headroom variation being greater than the one or more power headroom variation thresholds, and the power headroom variation is based on the power headroom determined at a first time and another power headroom determined at a second time. In some examples, the UE 115-b may receive control information that indicates a request for the power headroom report (e.g., pulling for power headroom report). The request for the power headroom report may be the trigger condition. Further, the UE 115-b may restart the timer (e.g., PHR periodic timer with a determined value phr-PeriodicTimer or PHR prohibit timer with a determined value phr-ProhibitTimer) after the power headroom report.

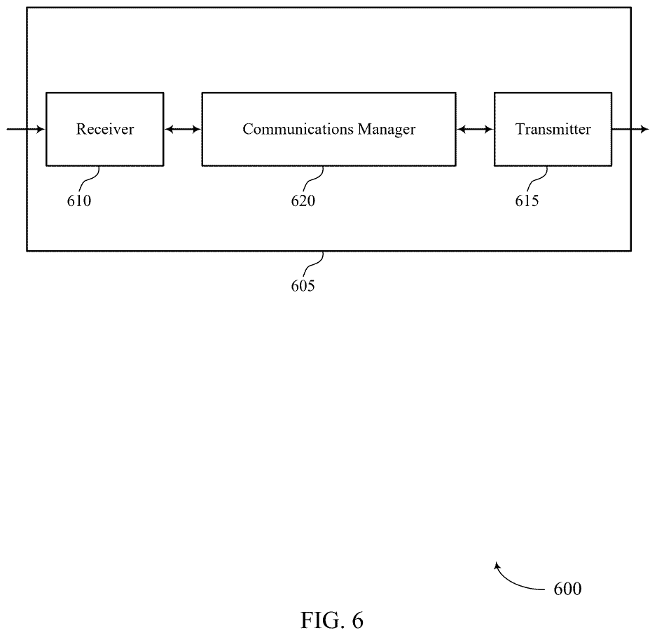

FIG. 6 shows a block diagram 600 of a device 605 that supports techniques for power headroom reporting in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for power headroom reporting). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for power headroom reporting). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of techniques for power headroom reporting as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. For example, the communications manager 620 is capable of, configured to, or operable to support a means for receiving first control signaling that indicates a set of multiple power headroom parameters including one or more power headroom thresholds, one or more power headroom variation thresholds, one or more timer values associated respectively with one or more power headroom values, or any combination thereof. The communications manager 620 is capable of, configured to, or operable to support a means for transmitting, to a network entity, a power headroom report based on a first power headroom satisfying a trigger condition associated one of the set of multiple power headroom parameters.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for more efficient utilization of communication resources.

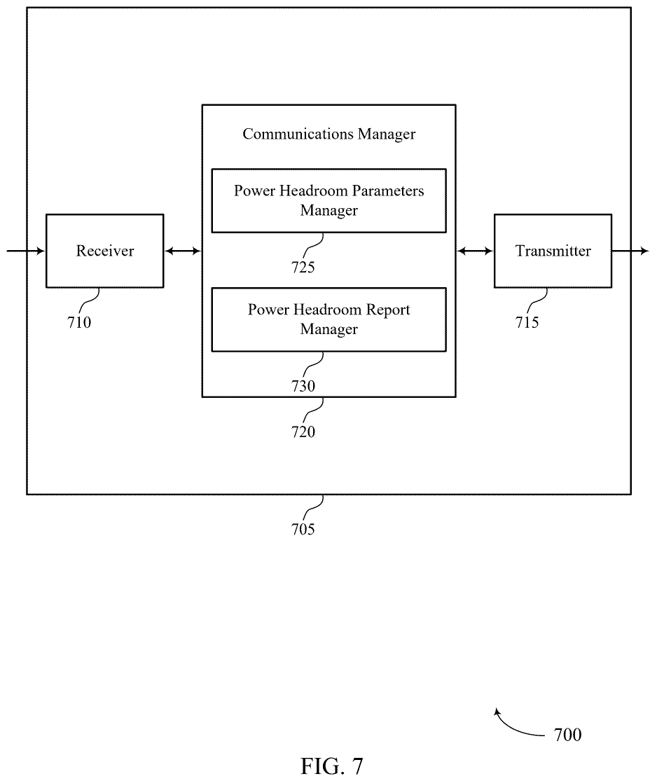

FIG. 7 shows a block diagram 700 of a device 705 that supports techniques for power headroom reporting in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for power headroom reporting). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for power headroom reporting). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for power headroom reporting as described herein. For example, the communications manager 720 may include a power headroom parameters manager 725 a power headroom report manager 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. The power headroom parameters manager 725 is capable of, configured to, or operable to support a means for receiving first control signaling that indicates a set of multiple power headroom parameters including one or more power headroom thresholds, one or more power headroom variation thresholds, one or more timer values associated respectively with one or more power headroom values, or any combination thereof. The power headroom report manager 730 is capable of, configured to, or operable to support a means for transmitting, to a network entity, a power headroom report based on a first power headroom satisfying a trigger condition associated one of the set of multiple power headroom parameters.

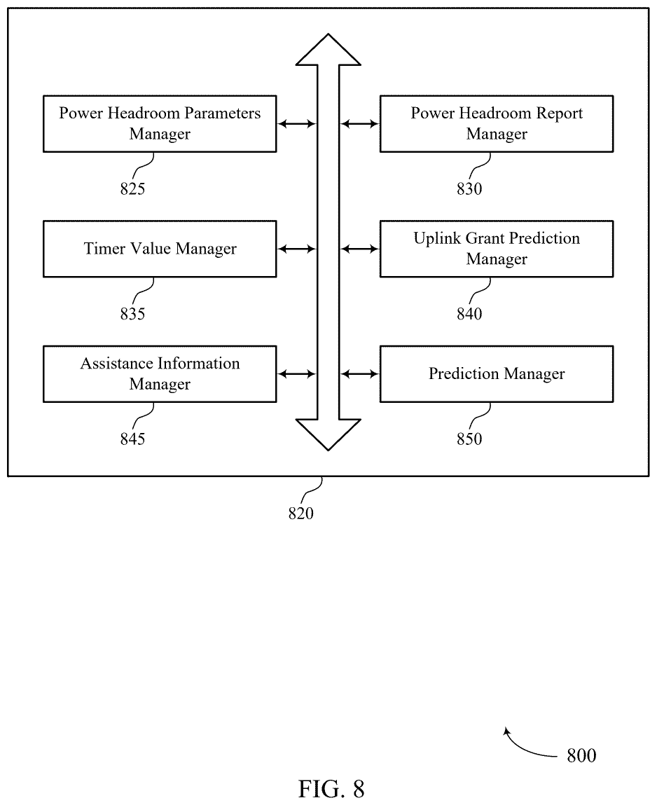

FIG. 8 shows a block diagram 800 of a communications manager 820 that supports techniques for power headroom reporting in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for power headroom reporting as described herein. For example, the communications manager 820 may include a power headroom parameters manager 825, a power headroom report manager 830, a timer value manager 835, an uplink grant prediction manager 840, an assistance information manager 845, a prediction manager 850, or any combination thereof. Each of these components, or components or subcomponents thereof (e.g., one or more processors, one or more memories), may communicate, directly or indirectly, with one another (e.g., via one or more buses).

The communications manager 820 may support wireless communication in accordance with examples as disclosed herein. The power headroom parameters manager 825 is capable of, configured to, or operable to support a means for receiving first control signaling that indicates a set of multiple power headroom parameters including one or more power headroom thresholds, one or more power headroom variation thresholds, one or more timer values associated respectively with one or more power headroom values, or any combination thereof. The power headroom report manager 830 is capable of, configured to, or operable to support a means for transmitting, to a network entity, a power headroom report based on a first power headroom satisfying a trigger condition associated one of the set of multiple power headroom parameters.

In some examples, the first power headroom is a predicted power headroom determined by the UE.

In some examples, each of the one or more power headroom variation thresholds is associated with a respective power headroom value.

In some examples, the one or more power headroom variation thresholds include a relative power headroom variation threshold.

In some examples, to support transmitting the power headroom report, the power headroom report manager 830 is capable of, configured to, or operable to support a means for transmitting the power headroom report based on the trigger condition including a power headroom variation satisfying the one or more power headroom variation thresholds, where the power headroom variation is based on the first power headroom determined at a first time and a second power headroom determined at a second time.

In some examples, the one or more timer values associated respectively with the one or more power headroom values include one or more periodic timer values associated respectively with the one or more power headroom values or one or more prohibit timer values associated respectively with the one or more power headroom values.

In some examples, the one or more timer values associated respectively with the one or more power headroom values include a look up table or a mapping function.

In some examples, to support transmitting the power headroom report, the timer value manager 835 is capable of, configured to, or operable to support a means for determining one of the one or more timer values based on the first power headroom. In some examples, to support transmitting the power headroom report, the power headroom report manager 830 is capable of, configured to, or operable to support a means for transmitting the power headroom report based on the trigger condition including an expiration of the one of the one or more timer values.

In some examples, the uplink grant prediction manager 840 is capable of, configured to, or operable to support a means for receiving second control signaling that indicates one or more parameters for prediction of an uplink grant.

In some examples, to support transmitting the power headroom report, the uplink grant prediction manager 840 is capable of, configured to, or operable to support a means for predicting an uplink grant. In some examples, to support transmitting the power headroom report, the power headroom report manager 830 is capable of, configured to, or operable to support a means for transmitting the power headroom report based on the trigger condition associated with the uplink grant.

In some examples, the trigger condition includes the uplink grant being associated with the first power headroom being less than the one or more power headroom thresholds.

In some examples, the trigger condition includes the uplink grant being associated with a power headroom variation being greater than the one or more power headroom variation thresholds and the power headroom variation is based on the first power headroom determined at a first time and a second power headroom determined at a second time.

In some examples, the assistance information manager 845 is capable of, configured to, or operable to support a means for transmitting assistance information that indicates a prediction capability or a set of UE power headroom parameters associated with the power headroom report.

In some examples, the set of multiple power headroom parameters are based on the prediction capability or the set of UE power headroom parameters.

In some examples, the power headroom report manager 830 is capable of, configured to, or operable to support a means for receiving second control information that indicates a request for the power headroom report.

In some examples, the prediction manager 850 is capable of, configured to, or operable to support a means for receiving second control information that indicates a request to enable a predicted power headroom.

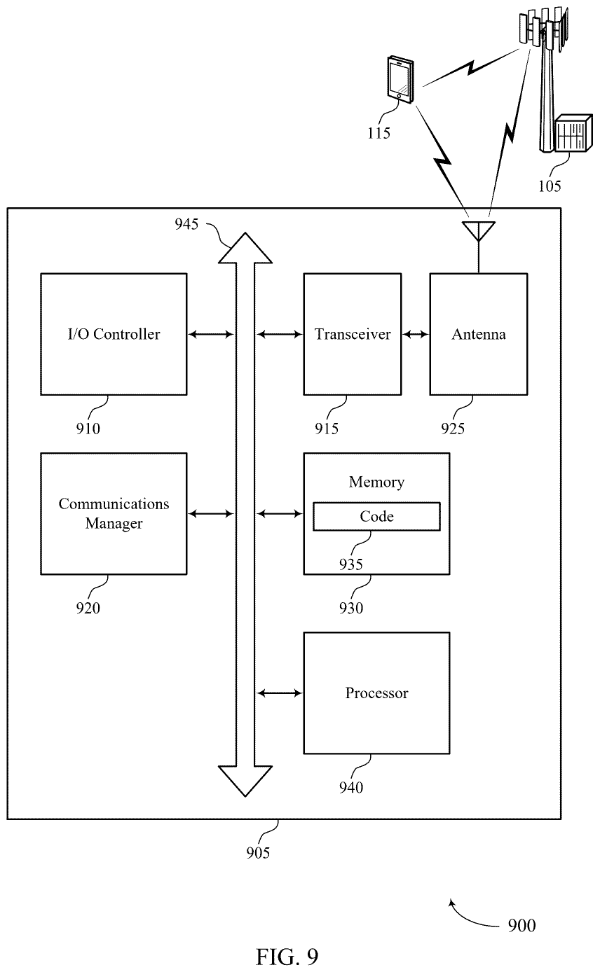

FIG. 9 shows a diagram of a system 900 including a device 905 that supports techniques for power headroom reporting in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting techniques for power headroom reporting). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communication in accordance with examples as disclosed herein. For example, the communications manager 920 is capable of, configured to, or operable to support a means for receiving first control signaling that indicates a set of multiple power headroom parameters including one or more power headroom thresholds, one or more power headroom variation thresholds, one or more timer values associated respectively with one or more power headroom values, or any combination thereof. The communications manager 920 is capable of, configured to, or operable to support a means for transmitting, to a network entity, a power headroom report based on a first power headroom satisfying a trigger condition associated one of the set of multiple power headroom parameters.

By including or configuring the communications manager 920 in accordance with examples as described herein, the device 905 may support techniques for more efficient utilization of communication resources, and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of techniques for power headroom reporting as described herein, or the at least one processor 940 and the at least one memory 930 may be otherwise configured to, individually or collectively, perform or support such operations.

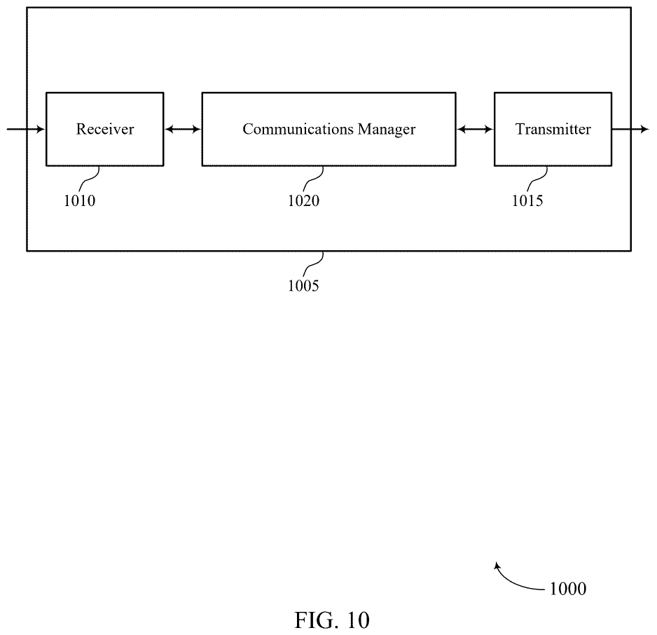

FIG. 10 shows a block diagram 1000 of a device 1005 that supports techniques for power headroom reporting in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of techniques for power headroom reporting as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. For example, the communications manager 1020 is capable of, configured to, or operable to support a means for outputting first control signaling that indicates a set of multiple power headroom parameters including one or more power headroom thresholds, one or more power headroom variation thresholds, one or more timer values associated respectively with one or more power headroom values, or any combination thereof. The communications manager 1020 is capable of, configured to, or operable to support a means for obtaining a power headroom report based on a first power headroom satisfying a trigger condition associated with one of the set of multiple power headroom parameters.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for more efficient utilization of communication resources.

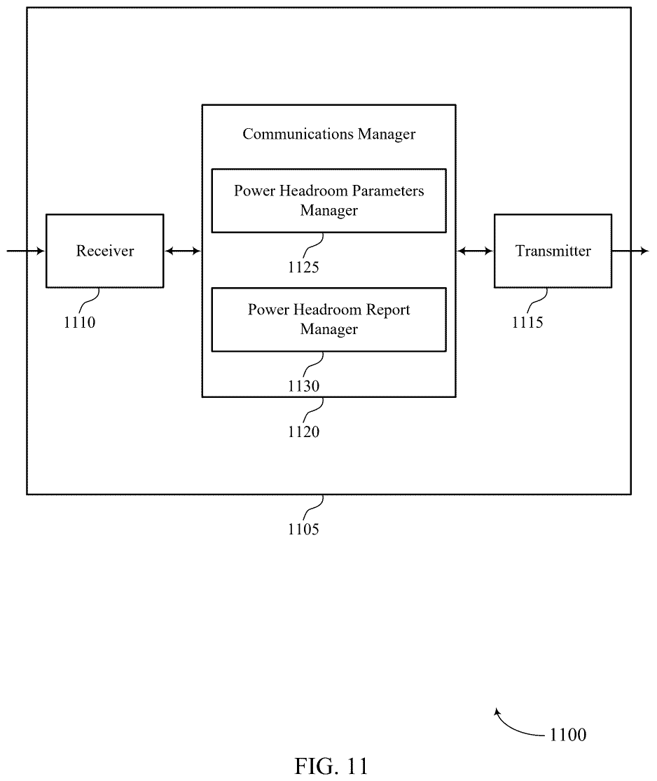

FIG. 11 shows a block diagram 1100 of a device 1105 that supports techniques for power headroom reporting in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for power headroom reporting as described herein. For example, the communications manager 1120 may include a power headroom parameters manager 1125 a power headroom report manager 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. The power headroom parameters manager 1125 is capable of, configured to, or operable to support a means for outputting first control signaling that indicates a set of multiple power headroom parameters including one or more power headroom thresholds, one or more power headroom variation thresholds, one or more timer values associated respectively with one or more power headroom values, or any combination thereof. The power headroom report manager 1130 is capable of, configured to, or operable to support a means for obtaining a power headroom report based on a first power headroom satisfying a trigger condition associated with one of the set of multiple power headroom parameters.

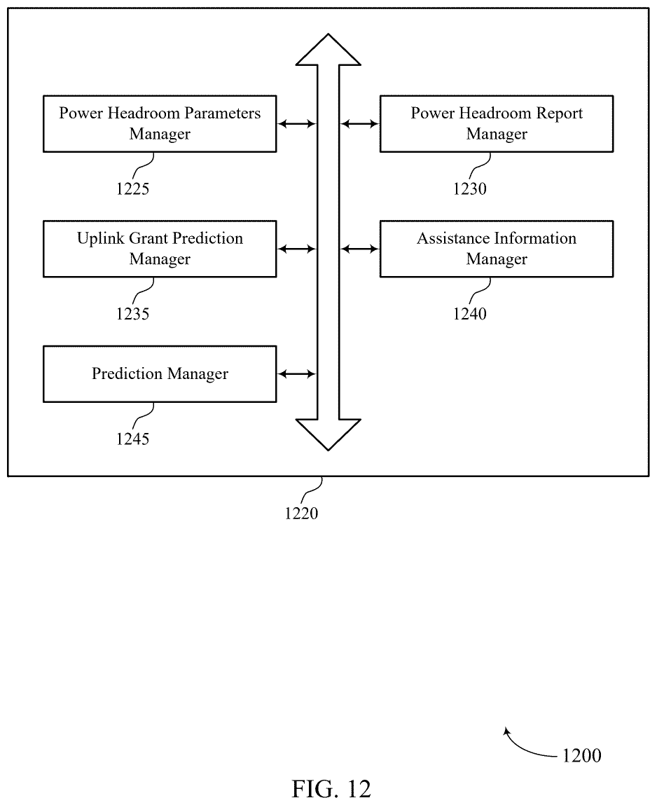

FIG. 12 shows a block diagram 1200 of a communications manager 1220 that supports techniques for power headroom reporting in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for power headroom reporting as described herein. For example, the communications manager 1220 may include a power headroom parameters manager 1225, a power headroom report manager 1230, an uplink grant prediction manager 1235, an assistance information manager 1240, a prediction manager 1245, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication in accordance with examples as disclosed herein. The power headroom parameters manager 1225 is capable of, configured to, or operable to support a means for outputting first control signaling that indicates a set of multiple power headroom parameters including one or more power headroom thresholds, one or more power headroom variation thresholds, one or more timer values associated respectively with one or more power headroom values, or any combination thereof. The power headroom report manager 1230 is capable of, configured to, or operable to support a means for obtaining a power headroom report based on a first power headroom satisfying a trigger condition associated with one of the set of multiple power headroom parameters.

In some examples, the first power headroom is a predicted power headroom determined by a UE.

In some examples, each of the one or more power headroom variation thresholds is associated with a respective power headroom value.

In some examples, the one or more power headroom variation thresholds include a relative power headroom variation threshold.

In some examples, the one or more timer values associated respectively with the one or more power headroom values include one or more periodic timer values associated respectively with the one or more power headroom values or one or more prohibit timer values associated respectively with the one or more power headroom values.

In some examples, the one or more timer values associated respectively with the one or more power headroom values include a look up table or a mapping function.

In some examples, the uplink grant prediction manager 1235 is capable of, configured to, or operable to support a means for outputting second control signaling that indicates one or more parameters for prediction of an uplink grant.

In some examples, the assistance information manager 1240 is capable of, configured to, or operable to support a means for obtaining assistance information that indicates a prediction capability or a set of UE power headroom parameters of a UE associated with the power headroom report.

In some examples, the set of multiple power headroom parameters are based on the prediction capability or the set of UE power headroom parameters.

In some examples, the power headroom report manager 1230 is capable of, configured to, or operable to support a means for outputting second control information that indicates a request for the power headroom report.

In some examples, the prediction manager 1245 is capable of, configured to, or operable to support a means for outputting second control information that indicates a request to enable a predicted power headroom.

In some examples, the power headroom parameters manager 1225 is capable of, configured to, or operable to support a means for outputting second control information that indicates a modification to the set of multiple power headroom parameters based on the power headroom report.

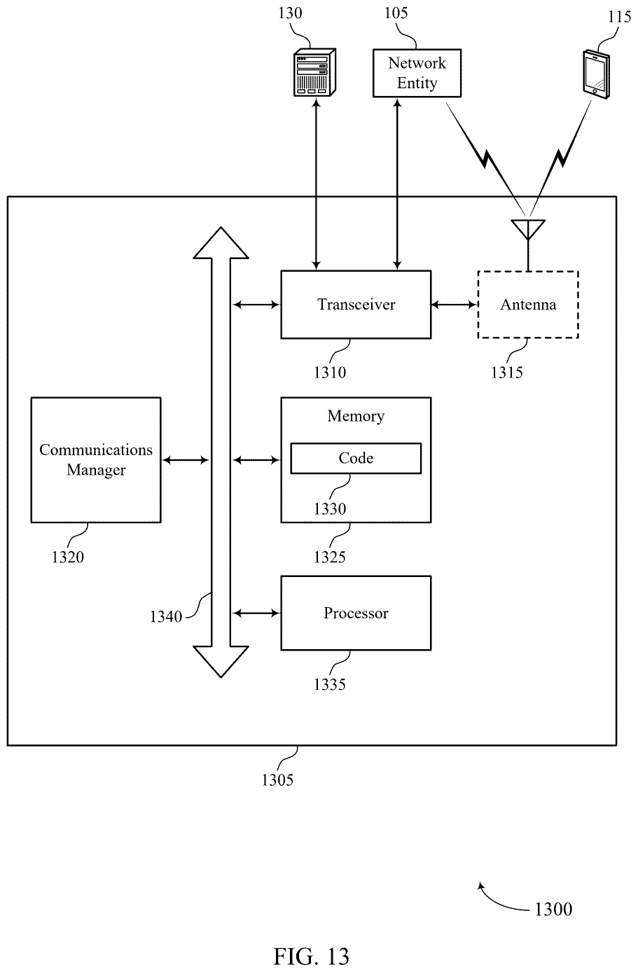

FIG. 13 shows a diagram of a system 1300 including a device 1305 that supports techniques for power headroom reporting in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting techniques for power headroom reporting). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communication in accordance with examples as disclosed herein. For example, the communications manager 1320 is capable of, configured to, or operable to support a means for outputting first control signaling that indicates a set of multiple power headroom parameters including one or more power headroom thresholds, one or more power headroom variation thresholds, one or more timer values associated respectively with one or more power headroom values, or any combination thereof. The communications manager 1320 is capable of, configured to, or operable to support a means for obtaining a power headroom report based on a first power headroom satisfying a trigger condition associated with one of the set of multiple power headroom parameters.

By including or configuring the communications manager 1320 in accordance with examples as described herein, the device 1305 may support techniques for more efficient utilization of communication resources, and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of techniques for power headroom reporting as described herein, or the at least one processor 1335 and the at least one memory 1325 may be otherwise configured to, individually or collectively, perform or support such operations.

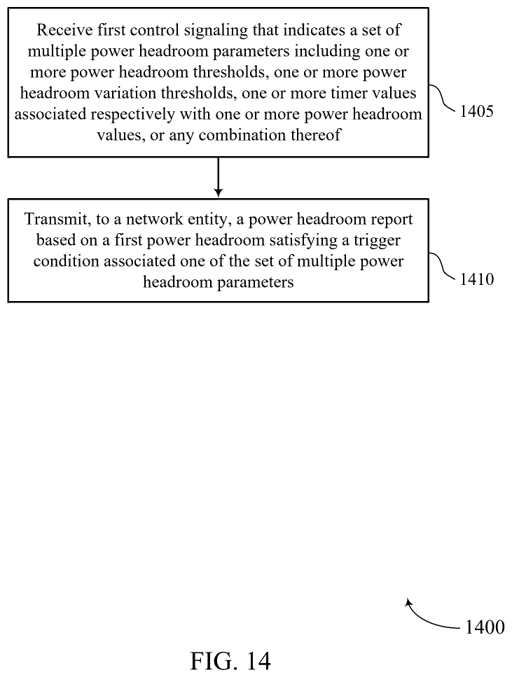

FIG. 14 shows a flowchart illustrating a method 1400 that supports techniques for power headroom reporting in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving first control signaling that indicates a set of multiple power headroom parameters including one or more power headroom thresholds, one or more power headroom variation thresholds, one or more timer values associated respectively with one or more power headroom values, or any combination thereof. The operations of 1405 may be performed in accordance with examples as disclosed herein. In some examples, aspects of the operations of 1405 may be performed by a power headroom parameters manager 825 as described with reference to FIG. 8.

At 1410, the method may include transmitting, to a network entity, a power headroom report based on a first power headroom satisfying a trigger condition associated one of the set of multiple power headroom parameters. The operations of 1410 may be performed in accordance with examples as disclosed herein. In some examples, aspects of the operations of 1410 may be performed by a power headroom report manager 830 as described with reference to FIG. 8.

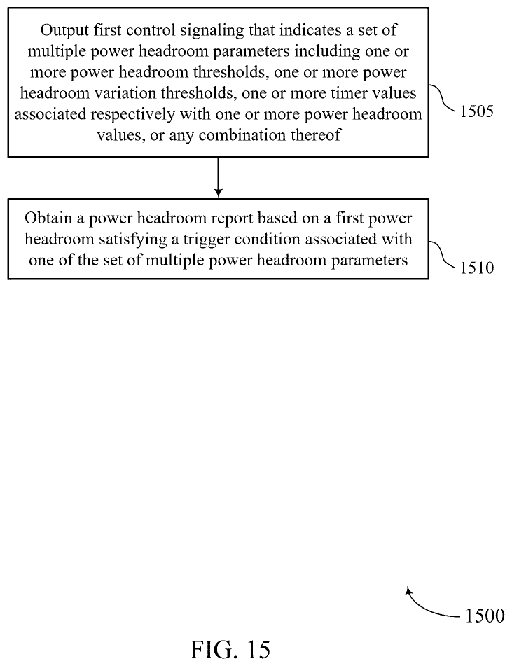

FIG. 15 shows a flowchart illustrating a method 1500 that supports techniques for power headroom reporting in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include outputting first control signaling that indicates a set of multiple power headroom parameters including one or more power headroom thresholds, one or more power headroom variation thresholds, one or more timer values associated respectively with one or more power headroom values, or any combination thereof. The operations of 1505 may be performed in accordance with examples as disclosed herein. In some examples, aspects of the operations of 1505 may be performed by a power headroom parameters manager 1225 as described with reference to FIG. 12.

At 1510, the method may include obtaining a power headroom report based on a first power headroom satisfying a trigger condition associated with one of the set of multiple power headroom parameters. The operations of 1510 may be performed in accordance with examples as disclosed herein. In some examples, aspects of the operations of 1510 may be performed by a power headroom report manager 1230 as described with reference to FIG. 12.

The following provides an overview of aspects of the present disclosure:

Aspect 1: A method for wireless communication by a UE, comprising: receiving first control signaling that indicates a plurality of power headroom parameters comprising one or more power headroom thresholds, one or more power headroom variation thresholds, one or more timer values associated respectively with one or more power headroom values, or any combination thereof; and transmitting, to a network entity, a power headroom report based at least in part on a first power headroom satisfying a trigger condition associated one of the plurality of power headroom parameters.

Aspect 2: The method of aspect 1, wherein the first power headroom is a predicted power headroom determined by the UE.

Aspect 3: The method of any of aspects 1 through 2, wherein each of the one or more power headroom variation thresholds is associated with a respective power headroom value.

Aspect 4: The method of any of aspects 1 through 2, wherein the one or more power headroom variation thresholds comprise a relative power headroom variation threshold.

Aspect 5: The method of any of aspects 1 through 2, wherein transmitting the power headroom report further comprises: transmitting the power headroom report based at least in part on the trigger condition comprising a power headroom variation satisfying the one or more power headroom variation thresholds, wherein the power headroom variation is based at least in part on the first power headroom determined at a first time and a second power headroom determined at a second time.

Aspect 6: The method of any of aspects 1 through 2, wherein the one or more timer values associated respectively with the one or more power headroom values comprise one or more periodic timer values associated respectively with the one or more power headroom values or one or more prohibit timer values associated respectively with the one or more power headroom values.

Aspect 7: The method of any of aspects 1 through 2, wherein the one or more timer values associated respectively with the one or more power headroom values comprise a look up table or a mapping function.

Aspect 8: The method of any of aspects 1 through 2, wherein transmitting the power headroom report further comprises: determining one of the one or more timer values based at least in part on the first power headroom; and transmitting the power headroom report based at least in part on the trigger condition comprising an expiration of the one of the one or more timer values.

Aspect 9: The method of any of aspects 1 through 2, further comprising: receiving second control signaling that indicates one or more parameters for prediction of an uplink grant.

Aspect 10: The method of aspect 1, wherein transmitting the power headroom report further comprises: predicting an uplink grant; and transmitting the power headroom report based at least in part on the trigger condition associated with the uplink grant.

Aspect 11: The method of aspect 10, wherein the trigger condition comprises the uplink grant being associated with the first power headroom being less than the one or more power headroom thresholds.

Aspect 12: The method of any of aspects 10 through 11, wherein the trigger condition comprises the uplink grant being associated with a power headroom variation being greater than the one or more power headroom variation thresholds and the power headroom variation is based at least in part on the first power headroom determined at a first time and a second power headroom determined at a second time.

Aspect 13: The method of any of aspects 1 through 12, further comprising: transmitting assistance information that indicates a prediction capability or a set of UE power headroom parameters associated with the power headroom report.

Aspect 14: The method of aspect 13, wherein the plurality of power headroom parameters are based at least in part on the prediction capability or the set of UE power headroom parameters.

Aspect 15: The method of aspect 1, further comprising: receiving second control information that indicates a request for the power headroom report.

Aspect 16: The method of any of aspects 1 through 15, further comprising: receiving second control information that indicates a request to enable a predicted power headroom.

Aspect 17: A method for wireless communication by a network entity, comprising: outputting first control signaling that indicates a plurality of power headroom parameters comprising one or more power headroom thresholds, one or more power headroom variation thresholds, one or more timer values associated respectively with one or more power headroom values, or any combination thereof; and obtaining a power headroom report based at least in part on a first power headroom satisfying a trigger condition associated with one of the plurality of power headroom parameters.

Aspect 18: The method of aspect 17, wherein the first power headroom is a predicted power headroom determined by a UE.

Aspect 19: The method of any of aspects 17 through 18, wherein each of the one or more power headroom variation thresholds is associated with a respective power headroom value.

Aspect 20: The method of any of aspects 17 through 18, wherein the one or more power headroom variation thresholds comprise a relative power headroom variation threshold.

Aspect 21: The method of any of aspects 17 through 18, wherein the one or more timer values associated respectively with the one or more power headroom values comprise one or more periodic timer values associated respectively with the one or more power headroom values or one or more prohibit timer values associated respectively with the one or more power headroom values.

Aspect 22: The method of any of aspects 17 through 18, wherein the one or more timer values associated respectively with the one or more power headroom values comprise a look up table or a mapping function.

Aspect 23: The method of any of aspects 17 through 18, further comprising: outputting second control signaling that indicates one or more parameters for prediction of an uplink grant.

Aspect 24: The method of any of aspects 17 through 23, further comprising: obtaining assistance information that indicates a prediction capability or a set of UE power headroom parameters of a UE associated with the power headroom report.

Aspect 25: The method of aspect 24, wherein the plurality of power headroom parameters are based at least in part on the prediction capability or the set of UE power headroom parameters.

Aspect 26: The method of aspect 17, further comprising: outputting second control information that indicates a request for the power headroom report.

Aspect 27: The method of any of aspects 17 through 26, further comprising: outputting second control information that indicates a request to enable a predicted power headroom.

Aspect 28: The method of any of aspects 17 through 27, further comprising: outputting second control information that indicates a modification to the plurality of power headroom parameters based at least in part on the power headroom report.

Aspect 29: A UE for wireless communication, comprising one or more memories storing processor-executable code, and one or more processors coupled with the one or more memories and individually or collectively operable to execute the code to cause the UE to perform a method of any of aspects 1 through 16.

Aspect 30: A UE for wireless communication, comprising at least one means for performing a method of any of aspects 1 through 16.

Aspect 31: A non-transitory computer-readable medium storing code for wireless communication, the code comprising instructions executable by one or more processors to perform a method of any of aspects 1 through 16.

Aspect 32: A network entity for wireless communication, comprising one or more memories storing processor-executable code, and one or more processors coupled with the one or more memories and individually or collectively operable to execute the code to cause the network entity to perform a method of any of aspects 17 through 28.

Aspect 33: A network entity for wireless communication, comprising at least one means for performing a method of any of aspects 17 through 28.

Aspect 34: A non-transitory computer-readable medium storing code for wireless communication, the code comprising instructions executable by one or more processors to perform a method of any of aspects 17 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first control signaling that indicates a plurality of power headroom parameters comprising one or more power headroom thresholds, one or more power headroom variation thresholds, one or more timer values associated respectively with one or more power headroom values, or any combination thereof; and
transmit, to a network entity, a power headroom report based at least in part on a first power headroom satisfying a trigger condition associated one of the plurality of power headroom parameters.

2. The UE of claim 1, wherein the first power headroom is a predicted power headroom determined by the UE.

3. The UE of claim 1, wherein each of the one or more power headroom variation thresholds is associated with a respective power headroom value.

4. The UE of claim 1, wherein the one or more power headroom variation thresholds comprise a relative power headroom variation threshold.

5. The UE of claim 1, wherein, to transmit the power headroom report, the one or more processors are individually or collectively further operable to execute the code to cause the UE to:
transmit the power headroom report based at least in part on the trigger condition comprising a power headroom variation satisfying the one or more power headroom variation thresholds, wherein the power headroom variation is based at least in part on the first power headroom determined at a first time and a second power headroom determined at a second time.

6. The UE of claim 1, wherein the one or more timer values associated respectively with the one or more power headroom values comprise one or more periodic timer values associated respectively with the one or more power headroom values or one or more prohibit timer values associated respectively with the one or more power headroom values.

7. The UE of claim 1, wherein the one or more timer values associated respectively with the one or more power headroom values comprise a look up table or a mapping function.

8. The UE of claim 1, wherein, to transmit the power headroom report, the one or more processors are individually or collectively further operable to execute the code to cause the UE to:
determine one of the one or more timer values based at least in part on the first power headroom; and
transmit the power headroom report based at least in part on the trigger condition comprising an expiration of the one of the one or more timer values.

9. The UE of claim 1, wherein the one or more processors are individually or collectively further operable to execute the code to cause the UE to:
receive second control signaling that indicates one or more parameters for prediction of an uplink grant.

10. The UE of claim 1, wherein, to transmit the power headroom report, the one or more processors are individually or collectively further operable to execute the code to cause the UE to:
predict an uplink grant; and
transmit the power headroom report based at least in part on the trigger condition associated with the uplink grant.

11. The UE of claim 10, wherein the trigger condition comprises the uplink grant being associated with the first power headroom being less than the one or more power headroom thresholds.

12. The UE of claim 10, wherein the trigger condition comprises the uplink grant being associated with a power headroom variation being greater than the one or more power headroom variation thresholds and the power headroom variation is based at least in part on the first power headroom determined at a first time and a second power headroom determined at a second time.

13. The UE of claim 1, wherein the one or more processors are individually or collectively further operable to execute the code to cause the UE to:
transmit assistance information that indicates a prediction capability or a set of UE power headroom parameters associated with the power headroom report.

14. The UE of claim 13, wherein the plurality of power headroom parameters are based at least in part on the prediction capability or the set of UE power headroom parameters.

15. The UE of claim 1, wherein the one or more processors are individually or collectively further operable to execute the code to cause the UE to:
receive second control information that indicates a request for the power headroom report.

16. The UE of claim 1, wherein the one or more processors are individually or collectively further operable to execute the code to cause the UE to:
receive second control information that indicates a request to enable a predicted power headroom.

17. A network entity, comprising:
one or more memories storing processor-executable code; and
one or more processors coupled with the one or more memories and individually or collectively operable to execute the code to cause the network entity to:
output first control signaling that indicates a plurality of power headroom parameters comprising one or more power headroom thresholds, one or more power headroom variation thresholds, one or more timer values associated respectively with one or more power headroom values, or any combination thereof; and
obtain a power headroom report based at least in part on a first power headroom satisfying a trigger condition associated with one of the plurality of power headroom parameters.

18. The network entity of claim 17, wherein the first power headroom is a predicted power headroom determined by a user equipment (UE).

19. The network entity of claim 17, wherein each of the one or more power headroom variation thresholds is associated with a respective power headroom value.

20. The network entity of claim 17, wherein the one or more power headroom variation thresholds comprise a relative power headroom variation threshold.

21. The network entity of claim 17, wherein the one or more timer values associated respectively with the one or more power headroom values comprise one or more periodic timer values associated respectively with the one or more power headroom values or one or more prohibit timer values associated respectively with the one or more power headroom values.

22. The network entity of claim 17, wherein the one or more timer values associated respectively with the one or more power headroom values comprise a look up table or a mapping function.

23. The network entity of claim 17, wherein the one or more processors are individually or collectively further operable to execute the code to cause the network entity to:
output second control signaling that indicates one or more parameters for prediction of an uplink grant.

24. The network entity of claim 17, wherein the one or more processors are individually or collectively further operable to execute the code to cause the network entity to:
obtain assistance information that indicates a prediction capability or a set of user equipment (UE) power headroom parameters of a UE associated with the power headroom report.

25. The network entity of claim 24, wherein the plurality of power headroom parameters are based at least in part on the prediction capability or the set of UE power headroom parameters.

26. The network entity of claim 17, wherein the one or more processors are individually or collectively further operable to execute the code to cause the network entity to:
output second control information that indicates a request for the power headroom report.

27. The network entity of claim 17, wherein the one or more processors are individually or collectively further operable to execute the code to cause the network entity to:
output second control information that indicates a request to enable a predicted power headroom.

28. The network entity of claim 17, wherein the one or more processors are individually or collectively further operable to execute the code to cause the network entity to:
output second control information that indicates a modification to the plurality of power headroom parameters based at least in part on the power headroom report.

29. A method for wireless communication by a user equipment (UE), comprising:
receiving first control signaling that indicates a plurality of power headroom parameters comprising one or more power headroom thresholds, one or more power headroom variation thresholds, one or more timer values associated respectively with one or more power headroom values, or any combination thereof; and
transmitting, to a network entity, a power headroom report based at least in part on a first power headroom satisfying a trigger condition associated one of the plurality of power headroom parameters.

30. A method for wireless communication by a network entity, comprising:
outputting first control signaling that indicates a plurality of power headroom parameters comprising one or more power headroom thresholds, one or more power headroom variation thresholds, one or more timer values associated respectively with one or more power headroom values, or any combination thereof; and
obtaining a power headroom report based at least in part on a first power headroom satisfying a trigger condition associated with one of the plurality of power headroom parameters.
